(19) United States
(12) Patent Application Publication
(10) Pub. No.: US 2005/0044895 A1
(43) Pub. Date: Mar. 3, 2005

(54) Method for putting color to glass or erasing color from colored glass

(75) Inventors: Takashi Yamate, Mie (JP); Nobuyuki Itakura, Osaka (JP); Shinji Nishikawa, Mie (JP); Hiroyuki Tamon, Mie (JP); Hiroshi Uemura, Saitama (JP); Kohei Kadono, Hyogo (JP); Tomoko Akai, Hyogo (JP); Masaru Yamashita, Osaka (JP); Tetsuo Yazawa, Osaka (JP); Shigeru Mori, Mie (JP); Yasushi Utagawa, Osaka (JP); Jiawei Sheng, Osaka (JP)

Correspondence Address: CROWELL & MORING LLP;INTELLECTUAL PROPERTY GROUP, P.O. BOX 14300, WASHINGTON, DC, 20044-4300, US

(73) Assignees: Central Glass Company, Limited, Yamaguchi (JP); National Institute of Advanced Industrial Science and Technology, Tokyo (JP); Osaka Seiko Garasu Kabushiki Kaisha, Osaka (JP)

(21) Appl. No.: 10/413,568

(22) Filed: Apr. 15, 2003

(30) Foreign Application Priority Data
Apr. 16, 2002 (JP) 2002-112929

(51) Int. Cl. C03C 23/00

(52) U.S. Cl. 65/111; 250/492.1; 204/157.15; 204/901

(57) ABSTRACT

The invention relates to a method for putting color to glass by irradiating a silicate glass, containing a non-bridging oxygen in its structure, with a laser light, thereby forming a non-bridging oxygen hole center therein to put a color to the glass. The invention further relates to a method for putting color to glass by irradiating a silver-ion-containing glass with a high-energy light, thereby forming silver particles in the glass through aggregation of silver ions to put a color to the glass. The invention further relates to a method for erasing color from colored glass by irradiating a colored portion of a glass with a laser light to selectively heat the colored portion by using a laser irradiation apparatus comprising (a) a laser oscillator, (b) a light modulator, (c) a condenser lens mounted on a linear translator, (d) an objective lens, and (e) a galvanometer mirror.

### BACKGROUND OF THE INVENTION

The present invention relates to a method for putting a color to glass or erasing color from colored glass by laser irradiation.

There are several proposals for marking glasses by laser irradiation (see Japanese Patent Laid-open Publications 2-242220, 3-124486, 4-71792, and 11-156568).

Japanese Patent Laid-open Publication 2-242220 discloses eyeglass frame parts (made of a laser absorbing transparent plastic) of which inside has a scorch pattern formed by laser irradiation.

Japanese Patent Laid-open Publication 3-124486 discloses a laser marking method in which a laser light is converged at an interior of an object. In this method, the laser convergence may cause the object to have cracks if the object is glass.

Japanese Patent Laid-open Publication 4-71792 discloses another laser marking method in which a transparent substrate interior is selectively made opaque by focusing a laser light into the transparent substrate. In this method, it may be difficult to precisely regulate the focal point of the laser light in a direction along the depth of the transparent substrate.

Japanese Patent Laid-open Publication 11-156568 discloses another laser making method in which a laser light is focused at an inside of an object using an fθ lens. In this method, the object is limited to a transparent material since the marking is made by cracks of the inside of the object.

There is known a phenomenon in which glass is provided with a color (e.g., brown color) by X-ray irradiation. The resulting colored glass, however, may become inferior in strength and transparency. Furthermore, such color is not stable under normal temperatures and gradually fades away. Therefore, X-ray irradiation is not a reliable measure for obtaining colored glass.

A colored glass can also be produced by adding a transition metal(s) as a colorant to a glass batch. Furthermore, a glass with a colored film can be produced by (a) dispersing an inorganic pigment or metal oxide in a transparent matrix (e.g., silica and titania) to prepare a colored film and then (b) coating a glass substrate with the colored film.

There is known a method for erasing color from colored glass in course of recycling colored glass. In this method, the entirety of colored glass is heated in a furnace for erasing color. It is, however, necessary to put a large energy for such heating. In contrast, colored glass may be broken by heating only a colored portion(s) thereof to save energy.

### SUMMARY OF THE INVENTION

It is an object of the present invention to provide a method for putting color to glass, which method is capable of providing glass with fine marks (such as letters, graphics, and drawings) by putting color thereto.

It is another object of the present invention to provide a method for erasing color from colored glass, which method is capable of providing glass with fine colorless marks (such as letter, graphics, and drawings) by partially erasing color, without adding damage (e.g., cracks) to the glass.

According to a first aspect of the present invention, there is provided a first method for putting color to glass, comprising irradiating a silicate glass, which contains a non-bridging oxygen in a structure of the silicate glass, with a laser light, thereby forming a non-bridging oxygen hole center in the silicate glass to put a color to the silicate glass.

According to a second aspect of the present invention, there is provided a second method for putting color to glass, comprising irradiating a silver-ion-containing glass with a high energy light, thereby forming silver particles in the glass through aggregation of silver ions to put a color to the glass.

According to a third aspect of the present invention, there is provided a third method for erasing color from colored glass, comprising irradiating a colored portion of a glass with a laser light to selectively heat the colored portion by using a laser irradiation apparatus comprising (a) a laser oscillator, (b) a light modulator, (c) a galvanometer mirror, and (d) an f θ lens, thereby turning the colored portion into a colorless portion.

### BRIEF DESCRIPTION OF THE DRAWINGS

FIG. 1 is a schematic view showing a first laser irradiation apparatus using an fθ lens for controlling the position of the focal point of the laser light;

FIG. 2 is a second laser irradiation apparatus using a condenser lens (Z lens) and an objective lens for controlling the position of the focal point of the laser light;

FIG. 3 is a view similar to FIG. 1, but showing a part of the first laser irradiation apparatus used in Example 5; and

FIG. 4 is a graph showing absorbance spectrum of two glasses respectively irradiated with X-ray and UV laser beam to put colors thereto.

### DESCRIPTION OF THE PREFERRED EMBODIMENTS

The above-mentioned first, second and third methods are superior in economy, since the energy loss is small in these methods and since the tact time is short in these methods.

The first method for putting color to glass according to the first aspect of the present invention is exemplarily described in detail in the following.

In the first method, a silicate glass, which contains a non-bridging oxygen in a structure of the silicate glass, is irradiated with a laser light, thereby forming a structural defect known as non-bridging oxygen hole center(s) (NBOHC) in the silicate glass to put a color to the silicate glass. A non-bridging oxygen is defined as being an oxygen bonded to a glass forming cation (e.g., Si⁴⁺) and to a modifying ion (e.g., Na⁺), as exemplarily shown by Si—O—Na. In contrast, a bridging oxygen is defined as being an oxygen bonded to two of glass forming cations, as exemplarily shown by Si—O—Si. The laser light irradiation can eliminate an electron from O-Na of Si—O—Na, thereby forming NBOHC. NBOHC is also described in columns 3 to 4 of U.S. Pat. No. 5,958,809, of which disclosure is incorporated by reference. NBOHC serves as a color center by absorbing visible light, thereby putting a color to the glass. It is possible by the first method to provide the silicate glass with fine marks (such as letters, graphics, and drawings) by putting color thereto. The resulting colored silicate glass is free from cracks and other defects.

In contrast with the first method, it is known to provide an alkali glass (e.g., soda lime silicate glass) with a color (e.g., brown color) by a high-energy electromagnetic wave (e.g., X-ray or γ-ray) irradiation, thereby forming NBOHC with high concentration in the glass.

In course of accomplishing the first method, the inventors unexpectedly found that NBOHC is also formed by irradiating a silicate glass (containing a non-bridging oxygen in its structure) with a low-energy electromagnetic wave (e.g., ultraviolet ray, visible light ray, or infrared ray) due to the induction of the non-linear optical effect such as multi-photon absorption. It is much easier to have reflection, diffraction and light convergence by ultraviolet ray, visible light ray or infrared ray, as compared with X-ray or γ-ray. Thus, it is possible to easily provide the silicate glass with fine marks (such as letters, graphics, and drawings) by scanning the silicate glass with a laser beam of ultraviolet ray, visible light ray or infrared ray.

The glass to be used in the first method is not particularly limited, as long as it is a silicate glass containing non-bridging oxygen in its structure. For example, it may be a soda lime silicate glass in the form of float plate glass produced by float method.

As mentioned above, the irradiation of a silicate glass, containing a non-bridging oxygen in its structure, with a laser light can form NBOHC, which is a color center to absorb visible light. It is possible to maintain coloring (caused by NBOHC) of the silicate glass for a long time by containing a small amount of an element (serving as electron capture center) in the glass. This element can be at least one of Ag, Sn and Eu. When the silicate glass contains Ag, the Ag content may be 0.005-0.5 wt %, preferably 0.01-0.2 wt %, more preferably 0.01-0.1 wt %, in terms of Ag₂O. When the silicate glass contains Sn, the Sn content may be 0.01-1 wt %, preferably 0.02-0.8 wt %, more preferably 0.02-0.4 wt %, in terms of SnO₂. When the silicate glass contains Eu, the Eu content may be 0.01-1 wt %, preferably 0.02-0.8 wt %, more preferably 0.02-0.4 wt %, in terms of Eu₂O₃.

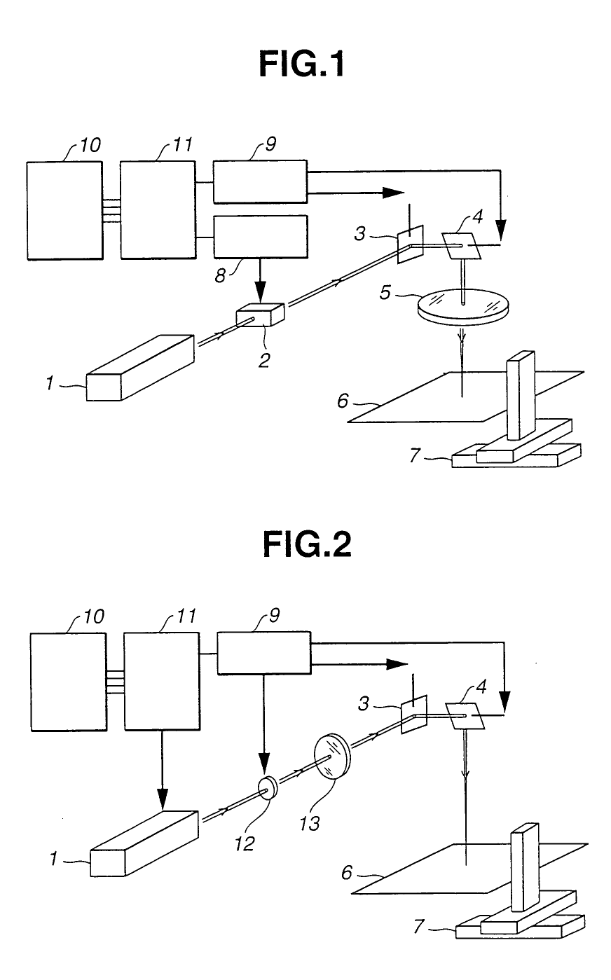

In the first method, the irradiation may be conducted by using a first apparatus comprising (a) a laser oscillator, (b) a light modulator, (c) a galvanometer mirror, (d) an fθ lens, and (e) a stage for supporting the silicate glass (see FIG. 1). Furthermore, it may be conducted by using a second apparatus comprising (a) a laser oscillator, (b) a light modulator, (c) a condenser lens (Z lens) mounted on a linear translator, (d) an objective lens, (e) a galvanometer mirror, and (f) a stage for supporting the silicate glass (see FIG. 2).

The laser oscillator may be a continuous laser oscillator for continuously emitting laser light or a pulsed laser oscillator for emitting laser light in a pulsed mode. Specific examples of high-output laser oscillator are carbon-dioxide laser oscillator, YAG laser oscillator, UV pulsed laser oscillator and argon ion laser oscillator.

In the first method, the laser light may be an ultraviolet light, visible light, near infrared light or infrared light. It is possible to use a light having a wavelength of from 100 nm to 1 mm (10⁶ nm). For example, it is possible to use a carbon-dioxide laser oscillator, argon ion laser oscillator or UV pulsed laser oscillator.

The light modulator serves as a switching device. The light modulator accurately regulates switching on and switching off of the laser light irradiation by changing the direction of the laser light propagation or by transmitting or shielding the laser light. It is possible to put discontinuous marks by suitably switching the light modulator on and off. The light modulator may be either an acoustic optical modulator (AOM) or electric optical modulator (EOM).

When AOM is switched on, AOM propagates supersonic into quartz glass by a transducer (piezoelectric device) to change RF wave in a radio frequency range into supersonic and diffract the laser light by diffraction grating through density fluctuation of quartz glass, thereby changing its optical path. When AOM is switched off, AOM allows the laser light to directly propagate into quartz glass.

EOM is a switching device for passing or shielding the laser light by changing the direction of polarization through applying voltage to the laser light.

The condenser lens (mounted on a linear translator and movable along the optical axis) and the objective lens of the first apparatus and the f θ lens of the second apparatus serve to focus the laser light (scanned arcuately by the galvanometer mirror) on the target. In other words, they serve to correct the focus position, thereby condensing the laser light on the target and improving resolution.

The galvanometer mirror is formed of a plurality of movable mirrors, for example, X-mirror and Y-mirror, and is capable of changing the optical axis of the laser light by changing the angles of the mirrors. Thus, it is possible to arbitrarily put marks on the target (silicate glass) by suitably adjusting the angles of X-mirror and Y-mirror to change the optical path and to move the focus point of the laser light on the target.

For example, it is possible to easily and finely write information about the production number, the production date, the name of manufacturer and the like and one-dimensional and two-dimensional bar codes on the silicate glass. Thus, the resulting silicate glass can be used as a memory medium. For example, it is possible to have a resolution by stopping down the laser light such that tens of lines are written within a distance of 1 mm.

Marks written on the silicate glass can be erased by heating the same at 100° C. or higher.

As is seen from FIG. 1, a first laser irradiation apparatus is described in detail as follows. In the first apparatus, an fθ lens is used for controlling the position of the focal point of the laser light.

In the first apparatus, the laser light emitted from a laser oscillator (argon ion laser oscillator or UV pulsed laser oscillator) 1 is reflected by X-mirror 3 and Y-mirror 4, then is transmitted through an fθ lens 5, and then reaches a target 6 (i.e., a silicate glass containing non-bridging oxygen in its structure in the first method), thereby putting a color to the exposed portion of the silicate glass. While the laser light is condensed onto the target 6, the target is scanned with the laser light by regulating the movement of the galvanometer mirror. The UV pulsed laser oscillator 1 may contain a built-in light modulator (AOM or EOM), which can be referred to as a so-called “Q-switch”. In case of the argon ion laser oscillator, the emitted light passes through AOM 2 and then is reflected by X-mirror 3 and Y-mirror 4 (see FIG. 1).

As shown in FIG. 1, AOM driver 8 converts the laser modulation signals (obtained by converting digital signals from the computer 10 into analog signals by the digital-to-analog converter 11) into radio frequency signals (RF signals) and generates supersonic in AOM 2 through a piezoelectric device (transducer). The laser light incident on AOM 2 is diffracted by a diffraction grating, thereby changing its optical path. As a result, the laser light is switched on or off.

In addition to the regulation of the galvanometer mirror, it is possible to scan the target 6 with the laser light to put some marks by suitably moving an XYZ-stage 7 (supporting thereon the target 6) having X- and Y-stages horizontally movable along the major surface of the target 6 and a Z-stage vertically movable relative to the target 6.

The scanning can be conducted as follows. Digital command data for regulating the movements of the X-mirror 3 and the Y-mirror 4 are previously input into a computer 10. Then, those data are converted into analog signals by a digital-to-analog converter 11. A servo driver 9 receives the analog signals, and drives and regulates the movements of the X-mirror 3 and the Y-mirror 4, based on the analog signals, thereby scanning the target 6 with the laser light as originally designed. Thus, it is easily possible to change the contents of writing on the target 6 by altering the digital command data.

As is seen from FIG. 2, a second laser irradiation apparatus is described in detail as follows. In the second apparatus, a condenser lens (Z lens) and an objective lens are used for controlling the position of the focal point of the laser light.

The second apparatus has a laser oscillator 1 (carbon-dioxide laser oscillator or UV pulsed laser oscillator). The UV pulsed laser oscillator may contain a built-in light modulator (AOM or EOM), which can be referred to as Q-switch. It is possible to regulate the laser beam diameter on the target 6 by moving a condenser lens (Z lens) 12 along the optical axis by a linear translator (not shown in FIG. 2) mounting thereon the condenser lens.

As is seen from FIG. 2, the laser light emitted from the laser oscillator 1 is passed through the condenser lens 12 and an objective lens 13, then is reflected by X-mirror 3 and Y-mirror 4, and then reaches the target 6, thereby putting a color to the exposed portion of the target. While the laser light is condensed onto the target 6, the target is scanned with the laser light by regulating the movement of the galvanometer mirror.

In addition to the regulation of the galvanometer mirror, it is possible to scan the target 6 with the laser light to put some marks by suitably moving an XYZ-stage 7 (supporting thereon the target 6) having X- and Y-stages horizontally movable along the major surface of the target 6 and a Z-stage vertically movable relative to the target 6.

The scanning can be conducted as follows. Digital command data for regulating the movements of the X-mirror 3 and the Y-mirror 4 are previously input into a computer 10. Then, those data are converted into analog signals by a digital-to-analog converter 11. A servo driver 9 receives the analog signals, and drives and regulates the movements of the condenser lens 12 and the X-mirror 3 and the Y-mirror 4, based on the analog signals, thereby scanning the target 6 with the laser light as originally designed. Thus, it is easily possible to change the contents of writing on the target 6 by altering the digital command data.

The movement of the stage 7 enables an efficient high-speed writing on the target 6. Furthermore, it is possible to put a plurality of marks (e.g., letters, drawings and bar codes) at a constant interval, for example, by repeating a process comprising the sequential steps of (a) moving the target 6 by a constant distance, (b) stopping this movement, and (c) scanning the target 6 with the laser light by moving the galvanometer mirror (X-mirror 3 and Y-mirror 4) to put the mark.

As stated above, it is possible by the first method to put a color to the silicate glass without causing damage (e.g., cracks) thereto. Furthermore, it is possible to erase the color by heating the silicate glass at 100° C. or higher. Therefore, it is easily possible to recycle the colored silicate glass by erasing the color, then breaking the colorless silicate glass into a cullet, and then using the cullet as a raw material in the float glass production.

The target of various shapes can be fixed to the stage 7 by changing a holder(s) for holding the target onto the stage 7. Thus, the target may have a shape of bottle in addition to platy shape.

The second method for putting color to glass according to the second aspect of the present invention is exemplarily described in detail in the following.

It is possible to erase the color of the glass obtained by the second method by heating the glass at a temperature of its softening point or higher. With this, the silver fine particles (the coloring source) diffuse in the glass, and thereby the color disappears. Therefore, the glass after erasing its color can easily be recycled.

A silver-ion-containing glass to be used in the second method can be produced, for example, by immersing a soda lime silicate glass in a silver-containing fused salt (e.g., silver nitrate) to replace sodium ions of the glass with silver ions of the fused salt. The resulting silver-ion-containing glass is transparent. The inventors unexpectedly found that silver fine particles accumulate at the surface of the glass by irradiating a silver-ion-containing glass with a high-energy light (e.g., high intensity laser light), that a yellow color is put to a light transmitted through the glass, and that a silver color is put to a light reflected from the glass due to the colloidal resonance absorption of the precipitated silver fine particles, thereby achieving the second method. With this, it is possible to put fine marks on a silver-ion-containing glass.

In contrast with the second method, it is possible to put a color to a silver-ion-containing glass by subjecting the glass to a radiation heating in a furnace to a temperature lower than its softening point. However, it is not possible to put fine marks by this radiation heating.

In the second method, the irradiation may be conducted by using the above-mentioned first or second apparatus of the first method. Therefore, all of the above descriptions relating to the first and second apparatuses can also be applied to the second method, and the overlapping descriptions are omitted from the following.

In the second method, the silver ions exist in an extremely small amount at the surface of the silver-ion-containing glass. Therefore, the color obtained by the second method can easily be erased by heating the glass at a temperature of its softening point or higher. The resulting glass is made to be colorless and transparent and can be subjected again to the second method to put a color.

In the second method, it is possible to obtain a dark color with a smaller laser output by the second apparatus using a carbon-dioxide laser oscillator or UV pulsed laser oscillator, as compared with the first apparatus using an argon ion laser oscillator.

In particular, the use of carbon-dioxide laser oscillator enables a high-speed coloring of a silver-ion-containing glass of a large surface area by a high-speed scanning of the glass with a laser light with high laser output, for example, to have a brown or yellow color.

As mentioned above, the first apparatus may use an argon ion laser (emitting visible light) as the light source, and in contrast the second apparatus may use a UV pulsed laser (emitting UV light) as the light source. Since UV light is shorter than visible light in wavelength, the UV laser may have a laser beam diameter smaller than that of the visible light laser. Therefore, it becomes possible by the UV laser to draw narrower lines and finer marks, as compared with the visible light laser.

Since visible light is transmitted through common glasses, it is possible to put a color to the inside of a glass (containing a light sensitive material) by visible light laser. Since glass absorbs infrared light, it is possible to put a color to the surface of a glass (containing a light sensitive material) by infrared light laser. It is possible by infrared light laser to put a color to a glass having a large surface area with high speed, since infrared light laser has in general high output and large spot diameter. It is possible to select an optimum type of laser in view of light transmission and light absorption of glass.

The third method for erasing color from colored glass according to the third aspect of the present invention is exemplarily described in detail in the following.

In the third method, the irradiation may be conducted by using the above-mentioned first or second apparatus of the first method. Therefore, all of the above descriptions relating to the first and second apparatuses can also be applied to the third method, and the overlapping descriptions are omitted from the following.

In the third method, the colored glass is not particularly limited in shape. It may have a shape of glass bottle as well as plate glass. Furthermore, the colored glass to be erased by the laser irradiation is not particularly limited, as long as its color can be erased thereby. It is possible to use a colored glass of which color can be eased by heating treatment. Examples of such colored glass are those having colors by the existence of the above-mentioned NBOHC, noble metal colloids and transition metal ions therein.

A colored glass containing such noble metal can be prepared by the sequential steps of (a) irradiating a glass containing a noble metal ion (e.g., Ag⁺) and a photo-reducing agent (e.g., Ce³⁺) with ultraviolet rays, (b) heating the glass to generate therein silver colloidal fine particles. The resulting colored glass can have a yellow color at its irradiated portion. Furthermore, a colored glass containing a noble metal can be prepared by irradiating a glass containing an oxidation-reduction ionic pair (a combination of a transition metal ion and an ion having at least two valences (e.g., As and Sb), such as a combination of Mn²⁺ and Fe³⁺) with ultraviolet rays to generate a colorant of Mn³⁺ therein.

It is possible by the third method to have a high contrast between the original colored portion and the colorless portion obtained by partially erasing the colored portion. Therefore, the glass obtained by the third method has a potential for the application in the field of memory medium.

It is possible by the third method to change a colored glass to a colorless glass with a shorter time and with a lower energy consumption, as compared with entirely heating the colored glass to erase its color.

The following nonlimitative Examples are illustrative of the present invention. In fact, Examples 1, 2-4 and 5 are respectively illustrative of the first to third aspects of the present invention.

### EXAMPLE 1

The second laser irradiation apparatus (shown in FIG. 2) was used for putting a color to a silicate glass containing non-bridging oxygen in its structure. A laser light was oscillated by the UV pulsed laser oscillator 1 to have a wavelength of 355 nm, a pulse width of 20 ns, a pulse energy of 117 μJ, an average output of 2.9W, and a repetition frequency of 25 kHz. This laser light was condensed by the condenser lens 2 into a laser beam, and this laser beam was reflected by the X-mirror 3 and the Y-mirror 4 toward the target 6. The target 6 was a transparent silicate glass plate having a thickness of 6 mm and widths of 100 mm and having a chemical composition of 72 wt % SiO₂, 16 wt % Na₂O, 10 wt % CaO, and 2 wt % Al₂O₃. The silicate glass plate was scanned with the laser beam with a scanning speed of 250 mm/sec.

The scanning was conducted by suitably switching on and off the Q switch built in the UV pulsed laser oscillator, by regulating the angles of the X-mirror 3 and the Y-mirror 4, and by adjusting the laser beam diameter to 3 μm. With this, it was possible to draw a line (width: 3 μm) of a pale brown color.

Then, it was possible to write a plurality of marks at a constant interval by horizontally moving the XYZ-stage 7.

Under the above-mentioned conditions, the silicate glass was scanned with the laser beam, thereby drawing a square (size: 20 mm×20 mm) of a pale brown color on the silicate glass. This square was found to have a visible light transmittance of 84.2% and no defect such as cracks. In contrast, the unexposed portion of the silicate glass was found to have a visible light transmittance of 88.7%.

In fact, the visible light transmittance was determined by measuring transmittance of a wavelength range of 340 nm to 1,800 nm with a 340-type automated spectrophotometer made by Hitachi Ltd. With this, it was found to have absorptions at 420 nm and 620 nm, corresponding to absorptions caused by NBOHC formed by irradiating the silicate glass with X-ray.

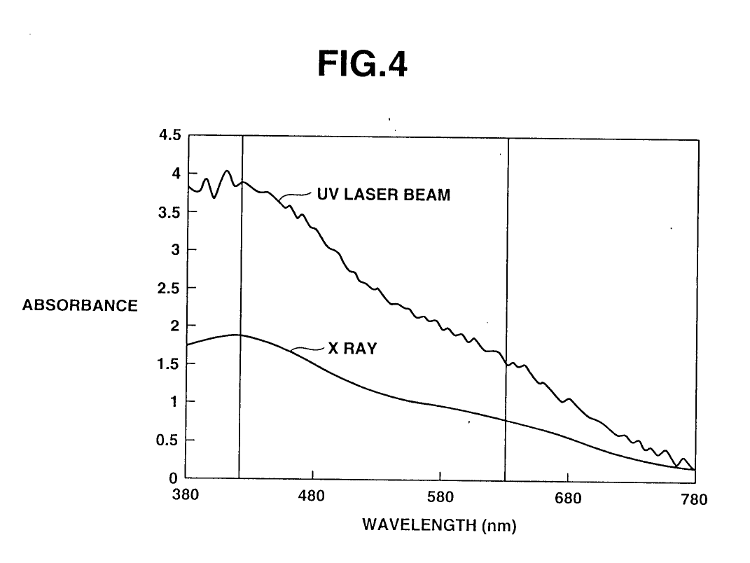

FIG. 4 is a graph showing absorbance spectrum of two glasses respectively irradiated with X-ray and UV laser beam to put colors thereto. In fact, one glass was irradiated with X-ray to form NBOHC therein. The absorbance relating to the UV laser beam irradiation shown in FIG. 4 is 100 times the actual absorbance relating to the UV laser beam irradiation. It is understood from FIG. 4 that the two spectrum curves show almost the same pattern. This means that the coloring by the UV laser beam irradiation was also caused by formation of NBOHC.

### EXAMPLE 2

The second laser irradiation apparatus (shown in FIG. 2) was used for putting a color to a silver-ion-containing glass. A laser light was oscillated by the carbon-dioxide laser oscillator 1 to have a wavelength of 10600 nm, a repetition frequency of 10 kHz or 20 kHz, and an average output of 1W, 2W, 5W, 10W or 20W. This laser light was condensed by the condenser lens 12 into a laser beam, and this laser beam was reflected by the X-mirror 3 and the Y-mirror 4 toward the target 6.

The target 6 was prepared as follows. At first, there was prepared by float method a soda-lime glass substrate (thickness: 5 mm; widths: 100 mm) having a chemical composition of 72 wt % SiO₂, 16 wt % Na₂O, 10 wt % CaO, and 2 wt % Al₂O₃. Then, the glass substrate was immersed for 5 min or 15 min in a fused salt (prepared by mixing 1 part by mol of AgNO₃ with 4 parts by mol of NaNO₃) heated at 590K (317° C.), thereby replacing Na ions of the glass surface with silver ions.

The target 6 (silver-ion-containing glass) was scanned with the laser light to have a line spacing (distance between center lines of adjacent two lines) of 25 μm, 100 μm or 250 μm with a scanning speed of 240 mm/s, 1200 mm/s or 5000 mm/s, thereby drawing a square (dimensions: 10 mm×10 mm) or rectangle (dimensions: 10 mm×90 mm) of a yellow or brown color.

It was possible to put a yellow or brown color to either the top surface or the bottom surface of the glass substrate in terms of float method. Specifically, the silver-ion-containing glass was colored to have a yellow color under a scanning speed of 240 mm/s when the average output was in a range of 1 to 20W. Under a scanning speed of 1200 mm/s, it was not colored with an output of 2W, but colored to have a brown color with 5W and a yellow color with 10W. Under a scanning speed of 5000 mm/s, it was not colored with an output of 2W, but colored to have a brown color with 20W and a yellow color with 50W.

It was confirmed that the color tone of the resulting colored glass did not change according to the period of time of the above-mentioned immersion. In contrast, the color concentration was darker with a longer period of time of the above-mentioned immersion. Furthermore, the color concentration was slightly darker at the bottom surface of the glass substrate, as compared with the top surface thereof. Still furthermore, the color concentration was darker with narrower line spacing.

It was possible to put a color to the silver-ion-containing glass with a short time. For example, only 2 seconds were necessary for drawing lines in a rectangular section (dimensions: 90 mm×10 mm) at a rate of 10 lines per 1 mm.

The color of the silver-ion-containing glass was completely erased by heating the glass at a temperature of its softening point or higher.

The stage 7 and its holder for holding the target 6 were arranged for securely holding glass bottle as well as plate glass.

### EXAMPLE 3

The second laser irradiation apparatus (shown in FIG. 2) was used for putting a color to a silver-ion-containing glass. A laser light was oscillated by the UV pulsed laser oscillator 1 to have a wavelength of 355 nm, a pulse width of 20 ns, a pulse energy of 80 μJ, an average output of 2W, and a repetition frequency of 25 kHz. This laser light was condensed by the condenser lens 12 into a laser beam, and this laser beam was reflected by the X-mirror 3 and the Y-mirror 4 toward the target 6.

The target 6 was prepared in the same manner as that of Example 2, except in that the immersion was conducted for 1 hr.

The target 6 (silver-ion-containing glass) was scanned with the laser light to have a line width of 10 μm with a scanning speed of 250 mm/s, thereby drawing a rectangle (dimensions: 9 mm×15 mm) of a yellow color.

It was possible to draw a plurality of rectangles at a constant interval by horizontally moving the XYZ-stage 7.

Furthermore, it is possible to adjust the line spacing to, for example, 2.5 μm, 5 μm, 10 μm, 15 μm, 25 μm, 50 μm, 100 μm or 200 μm.

Using the second apparatus shown in FIG. 2, the surface of the above silver-ion-containing glass was scanned with a laser beam having a pulse energy of 80 μJ and a shot distance of 10 μm with a scanning speed of 250 mm/sec, thereby drawing eight rectangles (dimensions: 9 mm×15 mm) of from pale yellow to brown colors with line spacings of 2.5 μm, 5 μm, 10 μm, 15 μm, 25 μm, 50 μm, 100 μm and 200 μm. After that, the visible light transmittance (340-1800 nm) of each rectangle was determined according to Japanese Industrial Standard (JIS) Z 8722, JIS R 3106 and JIS Z 8701 using 340-type automated spectrophotometer (made by Hitachi Ltd.). The results are shown in Table.

TABLE

| | | | | | | | | |
|---|---|---|---|---|---|---|---|---|
| Laser Beam Line Spacing | 2.5 | 5 | 10 | 15 | 25 | 50 | 100 | 200 |
| (μm) | | | | | | | | |
| Visible Light Transmittance | 46 | 46 | 55 | 59 | 64 | 72 | 79 | 82 |
| (%) | | | | | | | | |

It was possible to put a color to the entire major surface of the target 6 by scanning the target with the UV laser light, while the XYZ-stage 7 was horizontally moved at a speed of 100 mm/sec. This scanning was conducted with a laser beam diameter of 2 mm by not condensing the laser light by the condensation lens 12.

The color of the entire major surface of the target 6 (silver-ion-containing soda-lime glass) was erased by heating the same at a temperature of its softening point or higher.

### EXAMPLE 4

The first laser irradiation apparatus (shown in FIG. 1) was used for putting a color to a silver-ion-containing glass. A laser light was oscillated by the argon ion laser oscillator 1 to have a laser light output of 2.2W. This laser light was condensed by the fθ lens 5 to have a laser beam diameter of 50 μm. It was possible to arbitrarily draw a yellow line (width: 50 μm) by switching the laser light on and off with AOM 2 and by adjusting the angles of the X-mirror 3 and the Y-mirror 4.

The target 6 was prepared in the same manner as that of Example 2.

Furthermore, the letter “G” was written in a rectangular area (dimensions: 7 mm×6 mm) of the target 6 by adjusting the laser beam diameter to 50 μm with a scanning speed of 10 mm/sec. Then, it was possible to write a plurality of the same letters “G” at a constant interval by horizontally moving the XYZ-stage 7 at a constant interval and by stopping this horizontal movement for a period of time to write each letter “G”. That is, the horizontal movement alternates with this stopping. It is needless to say that the laser beam irradiation can be switched off by AOM during the horizontal movement. The irradiated portions were colored by the precipitation of silver fine particles to have a transmitted color of yellow and a reflected color of silver.

It was possible to put a color to the entire major surface of the target 6 by scanning the target with the laser light, while the XYZ-stage 7 was horizontally moved at a speed of 100 mm/sec. In this scanning, the laser output was increased to a higher level, and the laser beam diameter was adjusted to 2 mm without condensing the laser beam diameter. Then, the color of the entire major surface of the target 6 was erased by heating the same at a temperature of its softening point or higher.

The stage 7 and its holder for holding the target 6 were arranged for securely holding glass bottle as well as plate glass.

### EXAMPLE 5

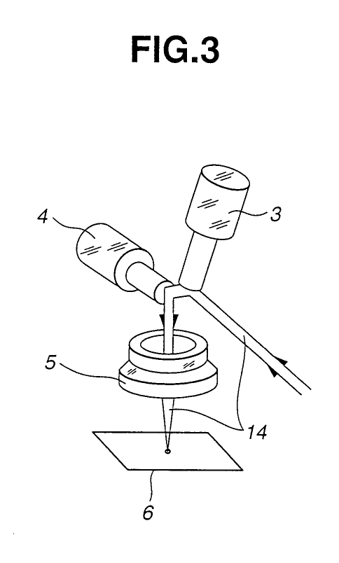

The first laser irradiation apparatus (shown in FIG. 1) was used for partially erasing color from glass. In fact, this apparatus was configured to have a part shown in FIG. 3. A laser light 14 was oscillated by the argon ion laser oscillator 1 to have a laser light output of 2W. This laser light was condensed by the fθ lens 5 to have a laser beam diameter of 50 μm. It was possible to arbitrarily draw a colorless line (width: 50 μm) by switching the laser light on and off with AOM 2 and by adjusting the angles of the X-mirror 3 and the Y-mirror 4. Then, similar to Example 4, it was possible to write a plurality of colorless marks at a constant interval by horizontally moving the XYZ-stage 7. The colorless portions were free from any defect such as cracks.

The target 6 (colored glass) was prepared by irradiating a glass (thickness: 2 mm; widths: 30 mm) with X-ray to form NBOHC therein, thereby putting a dark brown color to the glass.

It was possible in a short time to entirely erase the color of the target 6 by scanning the entire surface of the target with the laser light, while the XYZ-stage 7 was horizontally moved at a speed of 100 mm/sec. In this scanning, the laser output was increased to a higher level, and the laser beam diameter was adjusted to 2 mm without condensing the laser beam diameter.

The stage 7 and its holder for holding the target 6 were arranged for securely holding glass bottle as well as plate glass.

The entire contents of each of Japanese Patent Application Nos. 2001-162147 (filed May 30, 2001), 2001-261079 (filed Aug. 30, 2001), and 2002-112929 (filed Apr. 16, 2002), which are basic Japanese applications of the present application, are incorporated herein by reference.

1. A method for putting color to glass, comprising irradiating a silicate glass, which contains a non-bridging oxygen in a structure of the silicate glass, with a laser light, thereby forming a non-bridging oxygen hole center in the silicate glass to put a color to the silicate glass.

2. A method according to claim 1, wherein the silicate glass contains at least one element selected from the group consisting of Ag, Sn, and Eu,
wherein, when the silicate glass contains Ag, Ag is in an amount of 0.005-0.5 wt % in terms of Ag₂O,
wherein, when the silicate glass contains Sn, Sn is in an amount of 0.01-1 wt % in terms of SnO₂, and
wherein, when the silicate glass contains Eu, Eu is in an amount of 0.01-1 wt % in terms of Eu₂O₃.

3. A method according to claim 1, wherein the irradiating is conducted by using an apparatus comprising (a) a laser oscillator, (b) a light modulator, (c) a condenser lens mounted on a linear translator, (d) an objective lens, (e) a galvanometer mirror, and (f) a stage for supporting the silicate glass.

4. A method according to claim 1, wherein the irradiating is conducted by using an apparatus comprising (a) a laser oscillator, (b) a light modulator, (c) a galvanometer mirror, (d) an fθ lens, and (e) a stage for supporting the silicate glass.

5. A method according to claim 1, wherein the laser light is an ultraviolet light, visible light, near infrared light or infrared light.

6. A method according to claim 3, wherein the light modulator is an acoustic optical modulator or electric optical modulator.

7. A method according to claim 1, wherein the irradiating is conducted by moving a focal point of the laser light in the silicate glass with a plurality of galvanometer mirrors.

8. A method according to claim 1, wherein the irradiating is conducted by moving the silicate glass with a stage that supports the silicate glass and that is movable in a horizontal direction and/or vertical direction.

9. A silicate glass comprising a color that is indicative of information and that is obtained by the method of claim 1.

10. A method for putting color to glass, comprising irradiating a silver-ion-containing glass with a high energy light, thereby forming silver particles in the glass through aggregation of silver ions to put a color to the glass.

11. A method according to claim 10, wherein the high energy light is a laser light, and
wherein the irradiating is conducted by using a laser irradiation apparatus comprising (a) a laser oscillator, (b) a light modulator, (c) a condenser lens mounted on a linear translator, (d) an objective lens, and (e) a galvanometer mirror.

12. A method according to claim 10, wherein the high energy light is a laser light, and
wherein the irradiating is conducted by using a laser irradiation apparatus comprising (a) a laser oscillator, (b) a light modulator, (c) a galvanometer mirror, and (d) an fθ lens.

13. A method according to claim 11, wherein the laser oscillator is a carbon-dioxide laser oscillator, UV pulsed laser oscillator or argon ion laser oscillator, and
wherein the laser light is an infrared light, near infrared light, visible light or ultraviolet light.

14. A method according to claim 11, wherein the light modulator is an acoustic optical modulator or electric optical modulator.

15. A method according to claim 10, wherein the irradiating is conducted by moving a focal point of the high energy light in the glass with a plurality of galvanometer mirrors.

16. A method according to claim 10, wherein the irradiating is conducted by moving the glass with a stage that supports the glass and that is movable in a horizontal direction and/or vertical direction.

17. A colored glass prepared by the method of claim 10.

18. A colored glass according to claim 17, wherein the color has a shape indicative of information.

19. A method for erasing color from colored glass, comprising heating a colored glass prepared by the method of claim 10, at a temperature of a softening point of the colored glass or higher.

20. A method for erasing color from colored glass, comprising irradiating a colored portion of a glass with a laser light to selectively heat the colored portion by using a laser irradiation apparatus comprising (a) a laser oscillator, (b) a light modulator, (c) a galvanometer mirror, and (d) an fθ lens, thereby turning the colored portion into a colorless portion.

21. A method for erasing color from colored glass, comprising irradiating a colored portion of a glass with a laser light to selectively heat the colored portion by using a laser irradiation apparatus comprising (a) a laser oscillator, (b) a light modulator, (c) a condenser lens mounted on a linear translator, (d) an objective lens, and (e) a galvanometer mirror.

22. A method according to claim 20, wherein the light oscillator is a continuous laser oscillator or pulsed laser oscillator, and
wherein the laser light is an infrared light, near infrared light or ultraviolet light.

23. A method according to claim 20, wherein the light modulator is an acoustic optical modulator or electric optical modulator.

24. A method according to claim 20, wherein the irradiating is conducted by moving a focal point of the laser light in the glass with a plurality of galvanometer mirrors.

25. A method according to claim 20, wherein the irradiating is conducted by moving the glass with a stage that supports the glass and that is movable in a horizontal direction and/or vertical direction.

26. A method according to claim 20, wherein the colored portion is colored by the existence of non-bridging oxygen hole centers, a noble metal colloid or transition metal ions.

27. A method according to claim 26, wherein the irradiating is conducted, thereby making the non-bridging oxygen hole centers of the colored portion disappear or thereby changing valence of metal ions of the colored portion.

28. A method for partly erasing color from colored glass, comprising partly irradiating a colored portion of a glass with a laser light to partly heat the colored portion by using a laser irradiation apparatus comprising (a) a laser oscillator, (b) a light modulator, (c) a galvanometer mirror, and (d) an fθ lens, such that the colored portion partly turns into a colorless portion that is indicative of information.
